(19) United States
(12) Patent Application Publication
(10) Pub. No.: US 2025/0211883 A1
(43) Pub. Date: Jun. 26, 2025

(54) CONNECTOR MAXIMISING THE AVAILABLE TECHNICAL VOLUME

(71) Applicant: SAGEMCOM BROADBAND SAS, Bois-Colombes (FR)

(72) Inventors: Dominique SUSINI, Bois-Colombes (FR); Jérémy STANGALINI, Bois-Colombes (FR); Radu NEDELCU, Bois-Colombes (FR)

(21) Appl. No.: 18/989,137

(22) Filed: Dec. 20, 2024

(30) Foreign Application Priority Data
Dec. 22, 2023 (FR) FR2315189

(51) Int. Cl. H04R 1/02; H01R 12/75; H01R 13/645

(52) U.S. Cl. CPC H04R 1/02; H01R 12/75; H01R 13/6456; H04R 2420/09

(57) ABSTRACT

A piece of equipment includes an external casing having two first adjacent faces, and a connector positioned at least partially inside the external casing, the connector being arranged to be connected to a complementary connector by translation of the complementary connector with respect to the connector along an axis of connection comprised in a first bisector plane of first planes into which the two first faces extend.

The invention relates to the field of equipment provided with at least one connector.

### BACKGROUND OF THE INVENTION

Acoustic speaker enclosures, and in particular, smart and/or portable speaker enclosures, which are powered by a power cable provided at its free end with a so-called “straight” or “bent” (i.e. oriented at 90°) connector are known.

Generally, these speaker enclosures are provided to operate by being positioned in a quite particular position, so as to avoid twisting the power cable or exerting stresses on the connector risking damaging it.

Thus, when the power cable of the speaker enclosure is connected to the rear face of the speaker enclosure, the speaker enclosure must be installed, such that its lower face is placed on a horizontal flat surface (surface of a piece of furniture, for example). With the connector types which have just been mentioned, it is impossible to install this speaker enclosure in a position, such that its rear face is positioned against a vertical flat surface (surface of a wall, for example).

There are speaker enclosures which can be installed in several positions, and in particular, on a horizontal flat surface and against a vertical flat surface. The speaker enclosure thus comprises, in its casing, a guide path for the power cable, in which the cable is positioned to avoid damaging it.

The guide path thus impinges on the available technical volume inside the speaker enclosure, which requires either increasing the total size of the speaker enclosure to preserve the same technical volume, or reducing the technical volume.

However, currently, the manufacturers of speaker enclosures tend, on the contrary, to make the speaker enclosures as small as possible, such that increasing the size of the speaker enclosure is not desired. Reducing the technical volume is not desired either, as this could affect the correct operation of the speaker enclosure and lead to a drop in quality of the sound reproduction.

Another current solution for accommodating several positions consists of connecting an adapter to the power connector in order to change the orientation of the cable.

To this end, there are variable angle or fixed angle adapters. However, these adapters constitute additional parts which cause vibrations and interference noise during the operation of the speaker enclosure.

### AIM OF THE INVENTION

The invention aims for a solution making it possible to position a piece of equipment in several positions:
without damaging the cable nor the connector of the cable connected to this equipment;
without reducing the available technical volume inside of the equipment;
without generating disturbances (such as vibrations or interference noise).

### SUMMARY OF THE INVENTION

In view of achieving this aim, a piece of equipment is proposed comprising an external casing comprising two first adjacent faces, and a connector positioned at least partially inside the external casing, the connector being arranged to be connected to a complementary connector by translation of the complementary connector with respect to the connector along an axis of connection comprised in a first bisector plane of first planes into which the two first faces extend.

The configuration of the first faces and of the connector of the piece of equipment makes it possible to connect the complementary connector, either in a first position, or in a second position symmetrical to the first position with respect to the first bisector plane. The cable to which the complementary connector is connected can therefore extend, either parallel to one of the two first faces, or parallel to the other of the two first faces. Thus, the piece of equipment can be positioned, such that one of the two first faces rests on a horizontal flat surface, or such that the other of the two first faces is positioned against a vertical flat surface, without damaging the cable nor the connectors.

In addition, a piece of equipment such as described above is proposed, the connector being positioned in a corner of the external casing, where the two first faces join, the external casing comprising, at said corner, a receiving cavity, which extends into each of said first faces to define two connection positions, for the complementary connector, which are symmetrical against one another with respect to the first bisector plane.

In addition, a piece of equipment such as described above is proposed, in which the two first faces are perpendicular against one another.

In addition, a piece of equipment such as described above is proposed, in addition comprising an electronic board comprising a printed circuit on which the connector is mounted, the printed circuit extending into a plane perpendicular to the axis of connection.

In addition, a piece of equipment such as described above is proposed, in which the first faces of the external casing are bearing faces of the piece of equipment which is thus arranged to operate nominally when it is installed such that either one of the first faces rests on a horizontal flat surface, or the other of the first faces is positioned against a vertical flat surface.

In addition, a piece of equipment such as described above is proposed, the connector being a connector for powering the piece of equipment.

In addition, a piece of equipment such as described above is proposed, further comprising an internal casing, positioned inside the external casing, the connector being fixed to the internal casing.

In addition, a piece of equipment such as described above is proposed, the piece of equipment being an acoustic speaker enclosure.

In addition, a piece of equipment such as described above is proposed, in which the internal casing is a sound box of the acoustic speaker enclosure and the external casing is a shell of the acoustic speaker enclosure.

In addition, a complementary connector is proposed, arranged to be connected to the connector of the piece of equipment such as described above, the complementary connector comprising a body comprising two second faces, the axis of connection being comprised in a second bisector plane of second planes into which the two second faces extend.

In addition, a complementary connector such as described above is proposed, into which, when the complementary connector is connected to the connector, each second face extends parallel to one of the two first faces of the external casing of the equipment.

In addition, a complementary connector such as described above is proposed, arranged to be connected to the connector of the equipment such as described above, the complementary connector being arranged to be mounted at an end of a cable which extends from one of the two second faces of the body such that, when the complementary connector is connected to the connector and is located in one of the connection positions, the cable extends parallel to one of the first faces in the proximity of the complementary connector and, when the complementary connector is connected to the connector and is located in the other of the connection positions, the cable extends parallel to the other of the first faces in the proximity of the complementary connector.

In addition, a complementary connector such as described above is proposed, arranged to be connected to the connector of the equipment such as described above, the complementary connector being arranged to be mounted at a free end of a power cable.

In addition, a cable comprising a complementary connector such as described above is proposed, which is mounted at an end of the cable.

In addition, a system comprising a piece of equipment such as described above and a complementary connector such as described above are proposed, arranged such that, when the complementary connector is connected to the connector, each second face of the body of the complementary connector is positioned so as to be substantially flush with one of the first faces of the external casing of the piece of equipment.

The invention will be better understood in the light of the description below of a particular and non-limiting embodiment of the invention.

### BRIEF DESCRIPTION OF THE DRAWINGS

Reference will be made to the accompanying drawings, among which:

FIG. 1 represents a perspective view of the box of the speaker, as well as the frame and the cover of the external shell, these elements not being assembled;

FIG. 2 represents a rear and bottom, perspective view of the speaker enclosure;

FIG. 3 represents a bottom, perspective view of the speaker;

FIG. 4 represents a cross-sectional view, along a plane perpendicular to the rear face and to the lower face of the speaker, of the female connector of the speaker enclosure and of the male connector of the cable, while the male connector is not connected to the female connector;

FIG. 5 represents a perspective view of the cable, of the power electronic board, and of various components of the speaker enclosure;

FIG. 6 represents a cross-sectional view of the box, of the female connector, and of the electronic board on which it is mounted;

FIG. 7 represents a perspective view, from the inside of the box, of the electronic board on which the female connector is mounted;

FIG. 8 represents a view similar to that of FIG. 4, while the male connector is connected to the female connector and is located in the first connection position;

FIG. 9 represents a view similar to that of FIG. 4, while the male connector is connected to the female connector and is located in the second connection position;

FIG. 10 represents a view similar to that of FIG. 8, the speaker enclosure being placed on a horizontal flat surface;

FIG. 11 represents a view similar to that of FIG. 9, the speaker enclosure being positioned against a vertical flat surface.

### DETAILED DESCRIPTION OF THE INVENTION

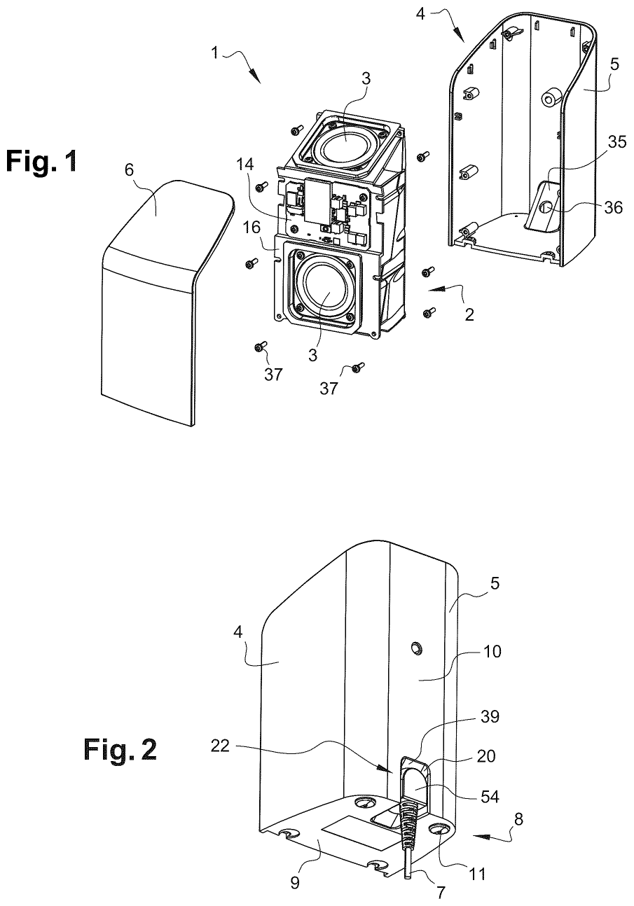

With reference to FIGS. 1 and 2, an acoustic speaker enclosure 1 comprises a sound box 2 and two loudspeakers 3 integrated in two distinct acoustic chambers formed inside the box 2.

One of the loudspeakers 3 is fixed to the upper face of the box 2. The diaphragm of said loudspeaker 3 therefore extends to the upper face of the box 2, which has an opening through which the diaphragm acoustically communicates with the outside of the box 2.

The other loudspeaker 3 is fixed to the front face of the box 2. The diaphragm of the loudspeaker 3 therefore extends to the front face of the box 2, which has an opening through which the diaphragm acoustically communicates with the outside of the box 2.

The speaker enclosure 1 also comprises an external shell 4 comprising a frame 5 and a cover 6. The frame 5 forms a rear face, a lower face and side faces of the shell 4 and of the speaker enclosure 1. The cover 6 forms an upper face and a front face of the shell 4 and of the speaker enclosure 1. The box 2 is positioned inside the volume defined by the shell 4.

The shell 4 therefore forms an external casing and the box 2 forms an internal casing of the speaker enclosure 1.

The speaker enclosure 1 is powered by a power cable 7 which is connected to the speaker enclosure 1 at a corner 8 defined by the lower face 9 and the rear face 10 of the shell 4 and therefore of the speaker enclosure 1.

The speaker enclosure 1 is provided to operate nominally, without damaging the cable 7, either by being positioned such that its lower face 9 rests on a horizontal flat surface (a piece of furniture, for example), or by being positioned such that its rear face 10 is positioned against a vertical flat surface (a wall, for example) and the right way round.

The lower face 9 optionally comprises at least one support element intended to be placed on a horizontal flat surface. In this case, these support elements are feet 11.

Thus, when it is said that the lower face 9 rests on a horizontal flat surface, this means either that the lower face 9 rests directly on said surface, or that the at least one support element rests on said surface (as is the case here, with the feet 11).

The rear face 10 may include fixing means for fixing it against the vertical flat surface. The fixing means are for example of the “keyhole” type and comprise a slot in which a screw fixed to the vertical flat surface slides.

When the rear face 10 of the speaker enclosure 1 is positioned against a vertical flat surface, the speaker enclosure 1 can be fixed to said vertical flat surface.

In this case, when a term relating to the positioning and applied to the speaker enclosure 1 or to the box 2 (for example, front, rear, upper, lower, internal, external, horizontal, etc.) is used, this term must be interpreted by considering that the speaker enclosure 1 is positioned in one of these two positions, and therefore that the speaker enclosure 1 and the box 2 are each in a nominal position.

The speaker enclosure 1 integrates a main electronic board 14 which comprises components making it possible for the speaker enclosure 1 to implement the functions for which it is designed. The electronic board 14 comprises, in particular, interface components with the user (button, indicator LED) and a radiofrequency communication module (in this case, Wi-Fi), which makes it possible for the speaker enclosure 1 to communicate with a piece of external equipment (in this case, with a set-top box, or STB).

The electronic board 14 is, in this case, positioned on an external wall of the front face 16 of the box 2, parallel to it (and therefore between the front face 16 of the box 2 and the front face of the cover 6 which forms the front face of the speaker enclosure 1).

The main electronic board 14, and all of the electronic components of the speaker enclosure 1, are powered via the power cable 7.

The speaker enclosure 1 therefore comprises a power connector, which is a female connector, in this case.

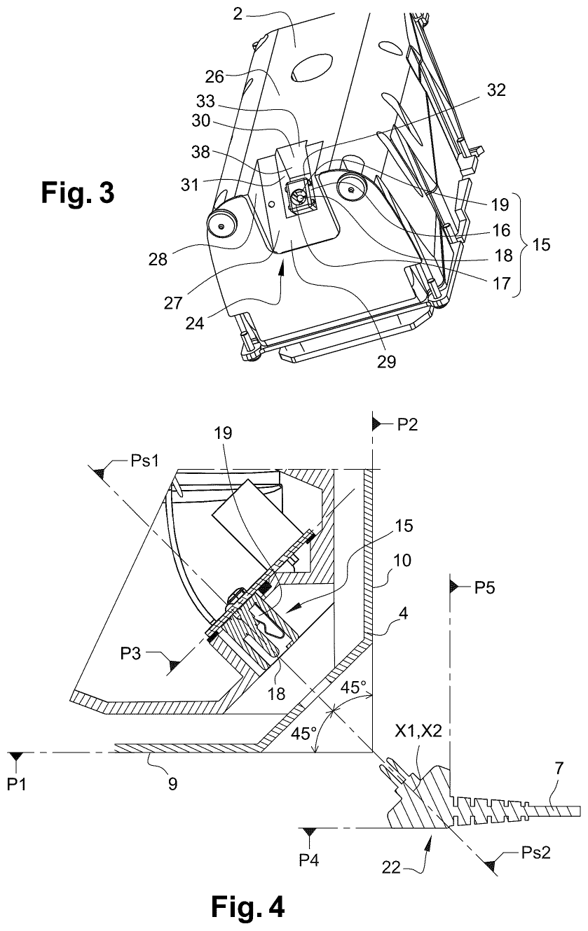

In reference to FIG. 3, the female connector 15, which is a “standard” connector in this case, comprises an outer parallelepiped-shaped casing 16 with rounded edges and corners.

The parallelepiped-shaped connector 15 has a cylindrically-shaped inlet and comprises a first connecting member and a second connecting member. The first connecting member is, in this case, a conductive rod 18, which extends into the cavity 17, from a bottom of the cavity, along a longitudinal axis of the cavity 17. The second connecting member is a loop 19 which extends from the bottom of the cavity 17, along an axis parallel to the longitudinal axis of the cavity 17, by being positioned between the internal wall of the cavity 17 and the conductive rod 18. The conductive rod 18 and the loop 19 form the two electrically conductive elements, between which, when the power cable 7 is connected, an external supply voltage is applied, transported by the power cable 7 and which makes it possible to power the speaker enclosure 1. An external supply current travels over the cable 7 under said external supply voltage to power the speaker enclosure 1.

The female connector 15 is positioned at least partially inside the shell 4, in this case, fully.

The female connector 15 is positioned in the corner 8 of the shell 4 where the lower face 9 and the rear face 10 join. The shell 4 comprises, at said corner 8, a receiving cavity 20 which extends into each of said faces 9, 10.

In reference to FIG. 4, the female connector 15 can be connected to a complementary connector 22 by translation of the complementary connector 22 with respect to said connector 15 along an axis of connection X1 comprised in a bisector plane Ps1 of planes P1, P2, into which two first faces of the speaker enclosure extend, in this case, the lower face 9 and the rear face 10 of the shell 4 (and therefore of the speaker enclosure 1), which are two adjacent faces.

The complementary connector 22 is a male connector, in this case, located at an end of the power cable 7.

As has been seen, the first faces 9, 10 of the shell 4 are bearing faces of the speaker enclosure 1, which can thus operate nominally when it is installed such that either one of the first faces (the lower face 9, or at the very least, its feet 11) rests on a horizontal flat surface, or the other of the first faces (the rear face 10) is positioned against a vertical flat surface. In this case, the lower face 9 and the rear face 10 are perpendicular against one another.

To connect the male connector 22, located at the free end of the power cable 7, to the female connector 15, this connector 22 must therefore be brought by moving it in translation along the axis of connection X1 which belongs to the plane Ps1, which is oriented at 45° with respect to a horizontal plane Pl and with respect to a vertical plane P2. There is therefore, in this case, an angle α=45° between the axis of connection X1 and each of the two faces 9, 10.

It is noted that the axis of connection X1 is also the axis of the cavity 17 and of the conductive rod 18 of the female connector 15.

Seen from the outside, the box 2 comprises a recess 24 located at a central part of the corner between the lower face 25 and the rear face 26 of the box 2 which extends towards the inside of the box 2.

The recess 24 comprises a first cavity 27 comprising first triangular-shaped side faces 28 and a first bottom 29, which is defined by a first inclined surface connecting the lower face 25 to the rear face 26 of the box 2. A second cavity 30 extends into the first bottom 29 of the first cavity 27 towards the inside of the box 2. This second cavity 30 comprises second trapezoidal-shaped side faces 31, a second bottom 32, and an inclined surface 33 connecting the second bottom 32 to the rear face 26 of the box 2.

The casing 16 of the female connector 15 is positioned at the second bottom 32 and its upper surface is flush with the first bottom 29.

When the speaker enclosure 1 is assembled, the internal walls of the shell 4 are very close to the external walls of the box 2.

The receiving cavity 20 of the shell 4 is located on the frame 5 and is defined by a recess 35 towards the inside of the shell 4 which has a shape similar to that of the recess 24. The receiving cavity 20 is similar to the first cavity 27—if this is only in the case of the shell 4, the bottom of the cavity does not leave the casing of the female connector 15 visible, but comprises a circular hole 36 through which the finger of the male connector 22 (which will be described below) can be inserted to be connected to the female connector 15.

It is noted that the recess 24 of the box 2 defines a free volume 38 above the female connector 15, which extends into the extension of the female connector 15 between the female connector 15 and the inclined surface 33.

This free volume 38 defines, in the receiving cavity 20 of the shell 4, a gripping recess 39 which, when the male connector 22 is connected, extends between the male connector 22 and the rear face 10 of the shell 4. The gripping recess 39 facilitates the passage of a finger of the user at an upper part of the receiving cavity 20 to grip the male connector 22.

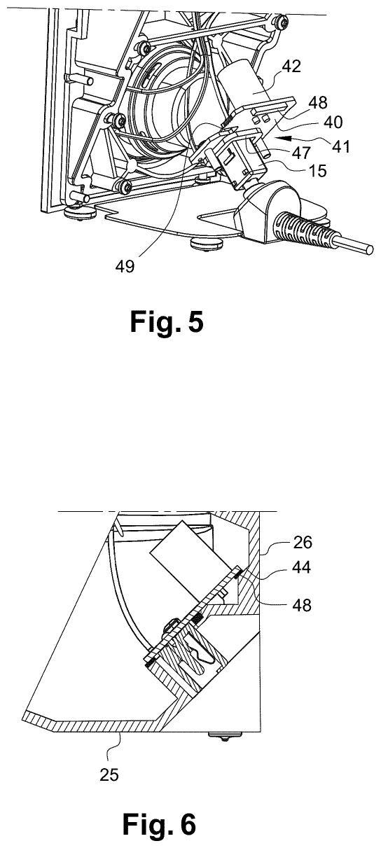

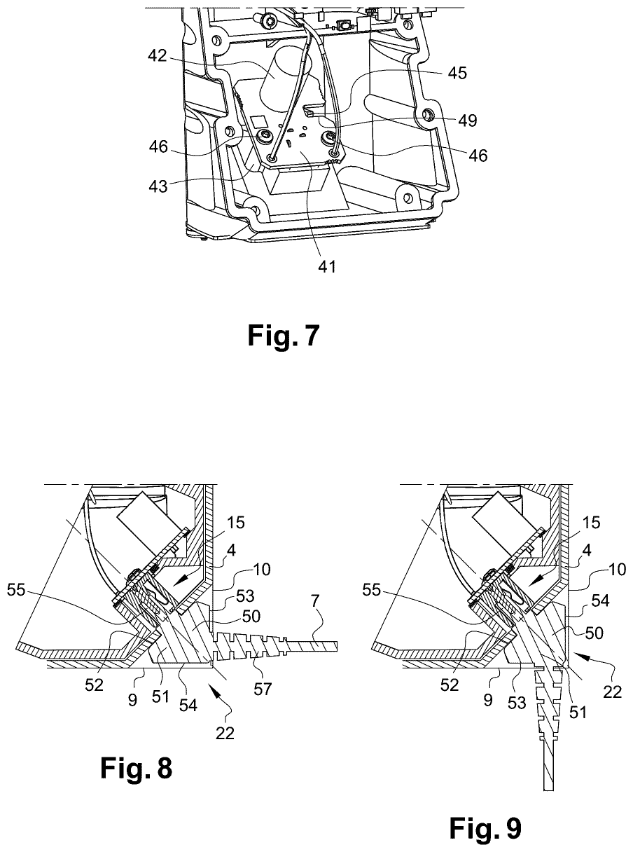

In reference to FIGS. 5 to 7, the female connector 15 is mounted on the printed circuit 40 of a power electronic board 41 and extends perpendicularly to it.

This electronic board 41 comprises power components which produce, from the external supply voltage and from the external electrical current, one or more internal supply voltages and one or more internal supply currents, which power the different electronic components of the speaker enclosure 1.

From among these power components, in particular a relatively large and heavy capacitor 42 is found.

The printed circuit 40 of the electronic board 41 is fixed to the internal wall of the box 2 (i.e. on the inside side of the box 2) at the recess 24 of the box.

Two tapped studs 43 extend from the internal wall of the box 2 to the internal walls of the second side faces 28 of the first cavity 27 of the recess 24, perpendicularly to the internal wall of the first bottom 29 of the first cavity 27.

The internal wall of the rear face 26 of the box 2 further comprises a ridge 44 which extends to the proximity of the recess 24. Finally, a coded stud 45 is formed on the internal wall at the recess 24.

The printed circuit 40 is fixed to the internal wall of the box 2 by screws 46, which extend into the tapped studs 43.

A seal 47 previously glued on the lower face of the printed circuit 40, by surrounding an implantation surface of the female connector 15, ensures the sealing between the inside and the outside of the box 2 at the female connector 15. A foam strip 48 is glued on the lower face of the printed circuit 40. The ridge 44 will press on the foam strip 48 and therefore on the printed circuit 40 in one same direction, but in a direction opposite the tightening of the screws 46, which stresses the electronic board 41 and makes it possible to prevent any imbalance phenomenon linked to the capacitor 42 welded on the electronic board 41.

The coded stud 45, positioned opposite a cutout 49 made in the printed circuit 40, prevents making a mistake on orientation of the electronic board 41 at the time of assembly, and it is therefore impossible to fix the electronic board 41 in an incorrect position. This makes it possible for the operator who will mount the electronic board 41 in the box 2 to increase speed and efficiency.

It is seen in FIG. 4, that the printed circuit 40 of the electronic board 41 extends into a plane P3 perpendicular to the axis of connection X. This particular arrangement of the female connector 15 has the advantage of limiting the loss of acoustic volume in the chambers of the loudspeakers 3 disposed inside the speaker enclosure 1.

Following the assembly of the components of the box 2, the box 2 is assembled using screws 37 in the shell 4 (which can be seen in FIG. 1), which serves as a rear covering. Thus, all the technical functions are invisible for the user, and this makes it possible to have an appliance with a pure and simple visual. The hole 36 enables the passage of the finger of the connector 22, such that the user easily connects the connector 22 in the female connector 15.

We will now focus more specifically, with reference to FIGS. 8 to 11, on the male connector 22.

The male connector 22 comprises a body 50 which comprises two side faces 51, a front face 52, a lower face 53, and a rear face 54.

The two side faces 51 each have a triangular shape (right-angled triangle) with cut corners.

The rear face 54 (which can be seen better in FIG. 2) has a lower rectangular-shaped part and an upper half-disc-shaped part.

Advantageously, the body 50 of the male connector 22 is obtained by overmoulding, so as to provide a monolithic male connector, which makes it possible to avoid generating interference noise or vibrations observed with the adapters of the prior art, when the speaker enclosure 1 is in operation.

The male connector 22 comprises a connecting member, which is a hollow finger 55, in this case. The finger 55 has a conductive internal surface and a conductive external surface, which form two electrically conductive elements, which are in contact with the two electrically conductive elements of the female connector 15 (the rod 18 and the loop 19) to transmit the external supply voltage and the external supply current.

The finger 55 extends from the front face 52 of the body 50 of the male connector 22, perpendicularly to it.

The conductive wires of the electrical cable 7, and the conductive internal surface and the conductive external surface of the finger 55, are connected to one another inside the body 50 of the male connector 22.

A frustoconical-shaped flexible sleeve 57 extends from the lower face 53 of the male connector 22. This flexible sleeve 57 makes it possible to handle the end of the cable 7 at the connector 22 without damaging the conductive wires, nor breaking the connection with the conductive internal and external surfaces.

It is seen that the finger 55 extends along a longitudinal axis X2 which itself extends into a second bisector plane Ps2 of planes P4, P5, into which the rear face 54 and the lower face 53 of the connector 22 extend.

The axis of connection X1 is combined with the longitudinal axis X2, and is therefore comprised in the second bisector plane Ps2.

There is therefore, in this case, an angle α=45° between the finger 55, and therefore the axis X2, and each of the two faces 53, 54.

To connect the power cable 7 to the speaker enclosure 1, and therefore the male connector 22 to the female connector 15, the male connector 22 is therefore brought into the receiving cavity 20 of the shell 4, which therefore extends as has been seen into the lower face 9 and into the rear face 10 of the shell 4, and therefore of the speaker enclosure 1.

The male connector 22 is shaped at 45°. The lower face 53 and the rear face 54 of the male connector 22 are perpendicular and extend symmetrically with respect to the longitudinal axis X2 of the finger 55 and therefore to the axis of connection X1, such that each of the two faces 53, 54 forms an angle α=45° with this axis. It will be noted that this axis constitutes an axis of symmetry of the assembly formed by the body 50 and by the male end (finger 55) of the connector 22. Moreover, the power cable 7 extends from the lower face 53 of the body 50 of the male connector 22.

Likewise, the two first faces (lower face 9 and rear face 10) of the shell 4 and therefore of the speaker enclosure 1 are perpendicular and extend symmetrically with respect to the axis of connection X1.

The body 50 of the male connector 22 therefore comprises two second faces (the lower face 53 and the rear face 54 of the male connector 22) oriented such that, when the male connector 22 is connected to the female connector 15, each second face 53, 54 extends parallel to one of the two first faces 9, 10 of the shell 4 of the speaker enclosure 1.

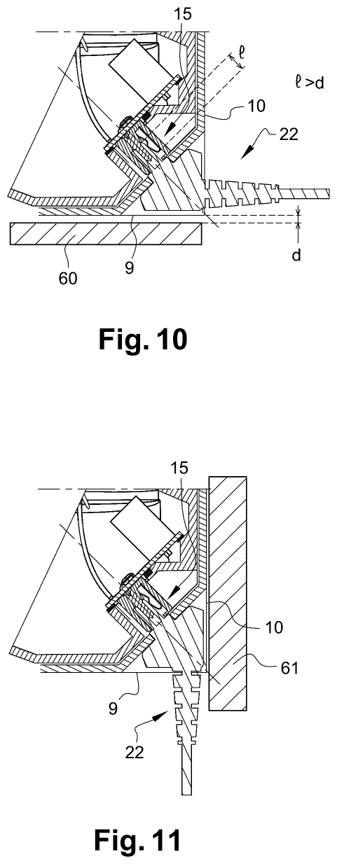

In FIGS. 8 and 10, the rear face 54 of the male connector 22 extends parallel to the lower face 9 of the shell 4 of the speaker enclosure 1, and the lower face 53 of the male connector 22 extends parallel to the rear face 10 of the shell 4 of the speaker enclosure 1.

In FIGS. 9 and 11, the rear face 54 of the male connector 22 extends parallel to the rear face 10 of the shell 4 of the speaker enclosure 1, and the lower face 53 of the male connector 22 extends parallel to the lower face 9 of the shell 4 of the speaker enclosure 1.

The double symmetry, of the first faces 9, 10 of the shell 4 with respect to the bisector plane Ps1 into which the direction of connection X1 extends, on the one hand, and second faces 51, 53 of the connector 22 with respect to the bisector plane Ps2, on the other hand, as well as the shape of the receiving cavity 20, makes it possible to introduce the male connector 22 into the female connector 15 along two connection configurations corresponding to two distinct orientations.

It is seen that the receiving cavity 20, which extends into the lower face 9 and into the rear face 10 of the external shell 4, defines two connection positions, for the male connector 22, which are symmetrical against one another with respect to the bisector plane Ps1: a first connection position, into which, when the male connector 22 is connected to the female connector 15, the cable 7 extends parallel to the lower face 9 of the shell 4 in the proximity of the male connector 22 (FIGS. 8 and 10) and a second connection position, into which, when the male connector 22 is connected to the female connector 15, the cable 7 extends parallel to the rear face 10 of the shell 4 in the proximity of the male connector 22.

This makes it possible to position the speaker enclosure 1, either by placing it on the horizontal flat surface of a piece of furniture 60 (FIG. 10), or by positioning it against the vertical flat surface of a wall (FIG. 11) and this, without risking damaging the power cable 7. Indeed, as is seen in these figures, whatever the considered position of the speaker enclosure 1, the power cable 7 remains aligned along the plane of the support (horizontal for the furniture 60 or vertical for the wall 61), thus avoiding bending or twisting of the cable 7.

As illustrated in these figures, the male connector 22 and the shell 4 are shaped such that when the male connector 22 is connected to the female connector 15, each second face (rear face 54 or lower face 53) of the male connector 22 is flush with one of the first faces (lower face 9 or rear face 10 of the shell 4 of the speaker enclosure 1).

The second faces 53, 54 of the male connector 22 are even preferably positioned slightly inside the shell 4 when the male connector 22 is connected to the female connector 15.

This configuration has the advantage of reducing the risk of accidental disconnection of the speaker enclosure 1, whatever the position of the speaker enclosure 1. Indeed, the male connector 22 cannot be disconnected, if the speaker enclosure 1 is positioned on a horizontal flat surface (the furniture 60, for example: see FIG. 10) or against a vertical flat surface (the wall 61, for example: see FIG. 11), as the stroke of the male connector 22 is stopped as soon as a face of the body 50 contacts the furniture 60 or the wall 61, thus preventing the disconnection of the speaker enclosure 1, even though the speaker enclosure 1 is ensured to always be powered.

In practice, there can be a slight different in level between the external walls of the second faces 53, 54 of the male connector 22 and the external walls of the first faces 9, 10 of the shell 4. However, as is seen in FIG. 10, the thickness of the male connector 22 is defined such that the distance d between the surface of the horizontal support 60 and the male connector 22 is always less than the length 1 of the loop 19 (and than that of the rod 18) of the female connector 15. Thus, the speaker enclosure 1 is always powered when the male connector 22 is located in one of the connection positions.

It is therefore seen that by combining a female connector 15 oriented at 45° in the speaker enclosure 1 and a male connector 22 shaped at 45°, the speaker enclosure 1 can be powered in two distinct positions, without risking damaging the power cable 7 and with a maximised acoustic volume. Indeed, it is not necessary to guide the electrical cable 7, for example through grooves shaped in the shell, which would have the disadvantage of reducing the acoustic volume of the speaker enclosure.

Naturally, the invention is not limited to the embodiment described, but comprises any variant entering into the field of the invention, such as defined by the claims.

The angle between the two first faces of the external casing of the speaker enclosure (and therefore between the two second faces of the complementary connector) is not necessarily an angle of 90°. This could be a different angle, for example, of 120°.

The connector of the equipment could be a male connector, and that of the cable could be a female connector.

The connecting members can be different from those mentioned, in this case.

The connectors are not necessarily power connectors: these can be connectors via which electrical signals of any nature travel (analogue or digital, audio signals, for example). These are not necessarily electrical connectors, these could be optical connectors, for example.

The invention can be implemented in any type of piece of equipment comprising a connector (not necessarily a speaker enclosure).

In addition, it is noted that the first faces of the piece of equipment are not necessarily flat. They can, for example, be rounded, over at least some of their surface. In this case, the first planes into which the first faces extend, define the directions towards which these first faces extend, and do not therefore coincide with the external walls of the first faces.

1. A piece of equipment comprising an external casing comprising two first adjacent faces, and a connector positioned at least partially inside the external casing, the connector being arranged to be connected to a complementary connector by translation of the complementary connector with respect to the connector along an axis of connection comprised in a first bisector plane of first planes into which the two first faces extend, the first faces of the external casing being bearing faces of the piece of equipment which is thus arranged to operate nominally when it is installed such that either one of the first faces rests on a horizontal flat surface, or the other of the first faces is positioned against a vertical flat surface.

2. The piece of equipment according to claim 1, wherein the connector is positioned in a corner of the external casing, where the two first faces join, the external casing comprising, at said corner, a receiving cavity, which extends into each of said first faces to define two connection positions, for the complementary connector, which are symmetrical against one another with respect to the first bisector plane.

3. The piece of equipment according to claim 1, wherein the two first faces are perpendicular against one another.

4. The piece of equipment according to claim 1, further comprising an electronic board comprising a printed circuit on which the connector is mounted, the printed circuit extending into a plane perpendicular to the axis of connection.

5. The piece of equipment according to claim 1, wherein the connector is a power connector of the equipment.

6. The piece of equipment according to claim 1, further comprising an internal casing, positioned inside the external casing, the connector being fixed to the internal casing.

7. The piece of equipment according to claim 1, wherein the piece equipment is an acoustic speaker enclosure.

8. The piece of equipment according to claim 6, wherein the internal casing is a sound box of the acoustic speaker enclosure and the external casing is a shell of the acoustic speaker enclosure.

9. A system comprising the piece of equipment according to claim 1, and a complementary connector arranged to be connected to the connector of the piece of equipment.

10. The system according to claim 9, the complementary connector comprising a body comprising two second faces, the axis of connection being comprised in a second bisector plane of second planes, into which the two second faces extend.

11. The system according to claim 9, wherein the complementary connector is arranged to be mounted at the free end of a power cable.

12. The system according to claim 9, wherein, when the complementary connector is connected to the connector, each second face extends parallel to one of the two first faces of the external casing of the piece of equipment.

13. The system according to claim 9, wherein the complementary connector is arranged to be mounted at an end of a cable which extends from one of the two second faces of the body such that, when the complementary connector is connected to the connector and is located in one of the connection positions, the cable extends parallel to one of the first faces in the proximity of the complementary connector and, when the complementary connector is connected to the connector and is located in the other of the connection positions, the cable extends parallel to the other of the first faces in the proximity of the complementary connector.

14. The system according to claim 9, wherein the system is arranged such that, when the complementary connector is connected to the connector, each second face of the body of the complementary connector is positioned so as to be substantially flush with one of the first faces of the external casing of the piece of equipment.
